(19) United States
(12) Patent Application Publication
(10) Pub. No.: US 2023/0385609 A1
(43) Pub. Date: Nov. 30, 2023

(54) INTELLIGENCE PROCESSING UNIT AND 3-DIMENSIONAL POOLING OPERATION

(71) Applicant: SigmaStar Technology Ltd., Xiamen (CN)

(72) Inventor: Zeng-Lei Yu, Shanghai (CN)

(21) Appl. No.: 18/087,210

(22) Filed: Dec. 22, 2022

(30) Foreign Application Priority Data
May 26, 2022 (CN) 202210589325.2

(51) Int. Cl. G06N 3/0464

(52) U.S. Cl. CPC G06N 3/0464

(57) ABSTRACT

A three-dimensional (3D) pooling operation method is provided. The method performs an operation on an input tensor to generate an output tensor. The input tensor includes multiple input tiles, and the output tensor includes multiple output tiles. The method includes the following steps: reading from an external memory one of the input tiles as a target input tile, and storing the target input tile in a memory; reading from the memory the target input tile; performing a first two-dimensional (2D) pooling operation on the target input tile R times to generate an intermediate tensor, R being a positive integer; performing a second 2D pooling operation on the intermediate tensor one time to generate a target output tile of the output tiles; and storing the target output tile in the memory.

This application claims the benefit of China application Serial No. CN202210589325.2, filed on May 26, 2022, the subject matter of which is incorporated herein by reference.

### BACKGROUND OF THE INVENTION

### 1. Field of the Invention

The present invention generally relates to artificial intelligence (AI), and, more particularly, to pooling operations of Convolutional Neural Network (CNN).

### 2. Description of Related Art

CNN, one of the common technologies in the field of AI, includes convolution operations and pooling operations. The main purpose of pooling operations is to reduce the data amount of the output data (tensor) of convolution operations. For electronic devices (e.g., image processing chips or circuits) that do not contain an intelligence processing unit (IPU), the pooling operations are usually performed by a central processing unit (CPU) or graphics processing unit (GPU). This is not an efficient approach because the CPU and GPU are not dedicated to pooling operations. However, implementing an IPU in the electronic device increases the complexity and cost of the electronic device. Therefore, designing a low-complexity and/or low-cost IPU is an important issue in this field.

### SUMMARY OF THE INVENTION

In view of the issues of the prior art, an object of the present invention is to provide an IPU and a three-dimensional (3D) pooling operation method, so as to make an improvement to the prior art.

According to one aspect of the present invention, a 3D pooling operation method for computing an input tensor to generate an output tensor is provided. The input tensor includes multiple input tiles, and the output tensor includes multiple output tiles. The method includes the following steps: (A) reading from an external memory one of the input tiles as a target input tile and storing the target input tile in a memory; (B) reading from the memory the target input tile; (C) performing a first two-dimensional (2D) pooling operation on the target input tile R times to generate an intermediate tensor, R being a positive integer; (D) performing a second 2D pooling operation on the intermediate tensor one time to generate a target output tile of the output tiles; and (E) storing the target output tile in the memory.

According to another aspect of the present invention, an IPU for processing an input tensor and generating an output tensor is provided. The input tensor includes multiple input tiles, and the output tensor includes multiple output tiles The IPU includes a memory, a direct memory access (DMA) unit, and a computing circuit. The DMA unit is configured to read from an external memory one of the input tiles as a target input tile and store the target input tile in the memory. The computing circuit is configured to perform following operations to perform a 3D pooling operation, which generates a target output tile of the output tiles, on the target input tile: (A) reading from the memory the target input tile; (B) performing a first 2D pooling operation on the target input tile R times to generate an intermediate tensor, R being a positive integer; and (C) performing a second 2D pooling operation on the intermediate tensor one time to generate the target output tile.

The technical means embodied in the embodiments of the present invention can solve at least one of the problems of the prior art. Therefore, compared with the prior art, the present invention can improve efficiency without significantly increasing complexity and/or cost of an electronic device.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of the electronic device according to an embodiment of the present invention.

FIG. 2 shows a schematic diagram of input data, intermediate data, and output data of a pooling operation according to an embodiment of the present invention.

FIG. 3 shows a schematic diagram of an input tensor or input tile according to another embodiment of the present invention.

FIG. 4 shows a flowchart of a 3D pooling operation according to an embodiment of the present invention.

FIG. 5 shows a detailed flowchart of step S440 in FIG. 4 according to an embodiment.

FIG. 6 shows a detailed flowchart of step S440 in FIG. 4 according to another embodiment.

FIG. 7 shows a detailed flowchart of step S450 in FIG. 4.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an IPU and a 3D pooling operation method. On account of that some or all elements of the IPU could be known, the detail of such elements is omitted provided that such detail has little to do with the features of this disclosure, and that this omission nowhere dissatisfies the specification and enablement requirements. Some or all of the processes of the 3D pooling operation method may be implemented by software and/or firmware, and can be performed by the IPU or its equivalent. A person having ordinary skill in the art can choose components or steps equivalent to those described in this specification to carry out the present invention, which means that the scope of this invention is not limited to the embodiments in the specification.

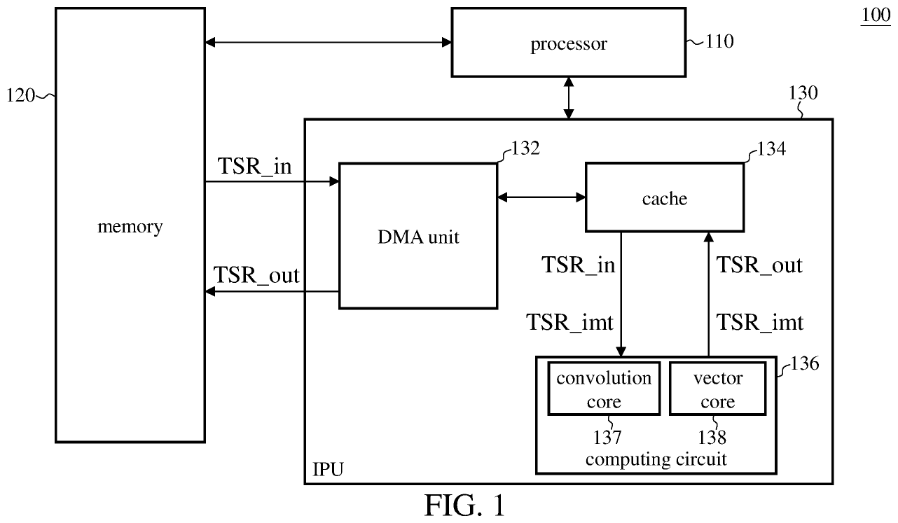

FIG. 1 is a functional block diagram of an electronic device according to an embodiment of the present invention. The electronic device 100 includes a processor 110, a memory 120, and an IPU 130. The processor 110, the memory 120, and the IPU 130 are coupled to each other, and both the processor 110 and the IPU 130 can access the memory 120. The IPU 130 includes a DMA unit 132, a cache 134, and a computing circuit 136. The computing circuit 136 includes a neural network computing core which includes a convolution core 137 (also referred to as a convolution computing circuit) for performing convolution operations and a vector core 138 (also referred to as a vector computing circuit) for performing pooling operations. The vector core 138 is designed for 2D pooling operations; that is, the vector core 138 is a 2D vector core for performing 2D pooling operations.

Continuing at FIG. 1, the memory 120 stores an outcome of a convolution operation of the IPU 130. The outcome is the output tensor of the convolution operation as well as the input tensor TSR_in of the pooling operation. During the pooling operation that the IPU 130 performs on the input tensor TSR_in, an intermediate tensor TSR_imt is generated and stored in the cache 134. The outcome of the pooling operation (i.e., the output tensor TSR_out) is stored in the cache 134, and then the DMA unit 132 writes the output tensor TSR_out into the memory 120. In some embodiments, the processor 110 can retrieve the output tensor TSR_out from the memory 120.

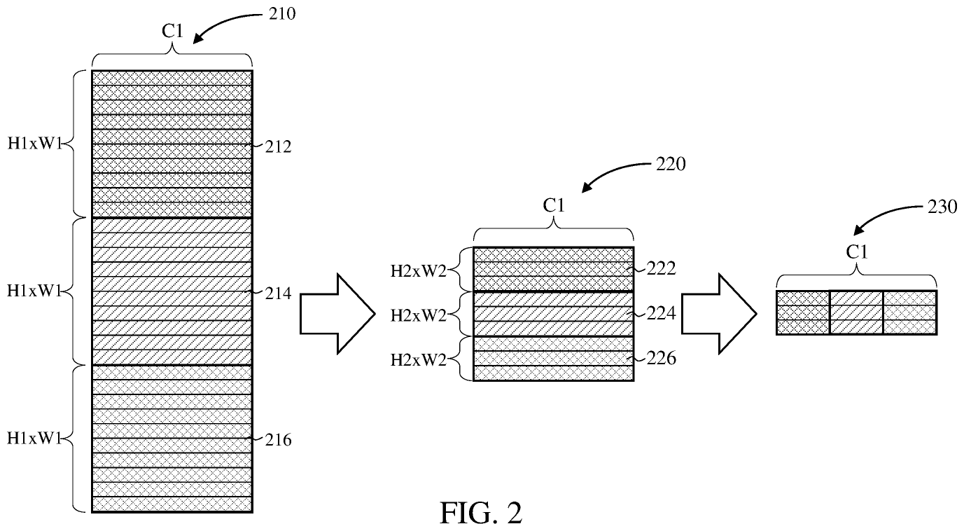

FIG. 2 shows a schematic diagram of the input data, intermediate data, and output data of the pooling operation according to an embodiment of the present invention. The input data 210 may be the aforementioned input tensor TSR_in or a part (e.g., an input tile) of the input tensor TSR_in. The intermediate data 220 is an outcome of at least one 2D pooling operation performed on the input data 210; that is, the intermediate data 220 is the aforementioned intermediate tensor TSR_imt or a part of the intermediate tensor TSR_imt. The output data 230 is an outcome of one 2D pooling operation performed on the intermediate data 220. The output data 230 may be the aforementioned output tensor TSR_out or a part (e.g., an output tile) of the output tensor TSR_out.

The max pooling and average pooling are two of the common 3D pooling operations, which are expressed in Equations (1) and (2) respectively.

$$MaxPool 3D\_out ( n , d , h , w , c ) = \qquad ( 1 )$$

$${max}_{l = 0 , … , Kd - 1} {max}_{p = 0 , … , Kh - 1} {max}_{q = 0 , … , Kw - 1} input ( n , Sd \times d + l ,$$

$$Sh \times h + p , Sw \times w + q , c )$$

$$AvgPool3D\_out ( n , d , h , w , c ) = {\sum }_{l = 0}^{Kd - 1} {\sum }_{p = 0}^{Kh - 1} {\sum }_{q = 0}^{Kw - 1} \frac{input ( n , Sd \times d + l , Sh \times h + p , Sw \times w + q , c )}{Kd \times Kh \times Kw} \qquad ( 2 )$$

where the five parameters (n, d, h, w, c) represent a point in the output vector (“n,” “d,” “h,” “w,” and “c” respectively representing the batch number (N), depth (D), height (H), width (W), and channel (C)), Kd, Kh, and Kw are the sizes of the sliding window in the depth (D), height (H), and width (W) directions, respectively, and Sd, Sh, and Sw are the strides of the sliding window in the depth (D), height (H), and width (W) directions, respectively. The principles of Equation (1) and Equation (2) are well known to people having ordinary skill in the art, and the details are omitted for brevity.

By analyzing Equation (1) and Equation (2), the present invention has adjusted them to Equation (3) and Equation (4), respectively. It can be seen from Equation (3) or Equation (4) that a 3D pooling operation is equivalent to a 2D pooling operation plus a one-dimensional (1D) pooling operation: for example, first processing the height (H) dimension and the width (W) dimension, followed by processing the depth (D) dimension.

$$MaxPool3D\_out ( n , d , h , w , c ) = \qquad ( 3 )$$

$${max}_{l = 0 , … , Kd - 1} ( {max}_{p = 0 , … , Kh - 1} {max}_{q = 0 , … , Kw - 1} input ( n , Sd \times d + l ,$$

$$Sh \times h + p , Sw \times w + q , c ) )$$

$$AvgPool3D\_out ( n , d , h , w , c ) = \qquad ( 4 )$$

$${\sum }_{l = 0}^{Kd - 1} \frac{1}{Kd} ( {\sum }_{p = 0}^{Kh - 1} {\sum }_{q = 0}^{Kw - 1} \frac{input ( n , Sd \times d + l , Sh \times h + p , Sw \times w + q , c )}{Kh \times Kw} )$$

Note that the batch number (N) dimension is omitted in the following discussions. However, people having ordinary skill in the art can apply the present invention to tensors with the batch number (N) dimension based on the following discussions.

Continuing at FIG. 2, FIG. 2 shows the four dimensions of data: the depth (D), height (H), width (W), and channel (C). For example, the input data 210 contains three sub-tensors (the sub-tensor 212, sub-tensor 214, and sub-tensor 216) in the depth (D) dimension, and each sub-tensor is a 3D data (with the height (H), width (W), and channel (C) being H1, W1 , and C1 respectively). As shown in FIG. 2, after the 2D pooling operation (which, for example, turns the input data 210 into the intermediate data 220 and turns the intermediate data 220 into the output data 230), the size of the channel (C) dimension remains unchanged (i.e., C1).

In some embodiments, the width of the cache 134 is related to the channel (C) dimension and the data format of the tensors (including the input tensor TSR_in, intermediate tensor TSR_imt, and output tensor TSR_out). For example, if the width of the cache 134 is 256 bits and the data format of the tensors is INT16 (i.e., a channel contains data of 16 bits), each row of the cache 134 can store at most 16 channels. In the example of FIG. 2, a row of the cache 134 stores C1 channels. That is to say, if H1×W1=10, the sub-tensor 212 is stored in the n^{th} to (n+9)^{th} rows of the cache 134 (n being an integer), the sub-tensor 214 is stored in the (n+10)^{th} to (n+19)^{th} rows of the cache 134, and the sub-tensor 216 is stored in (n+20)^{th} to (n+29)^{th} rows of the cache 134. C1 is less than or equal to the width of the cache 134 divided by the data format of the tensors.

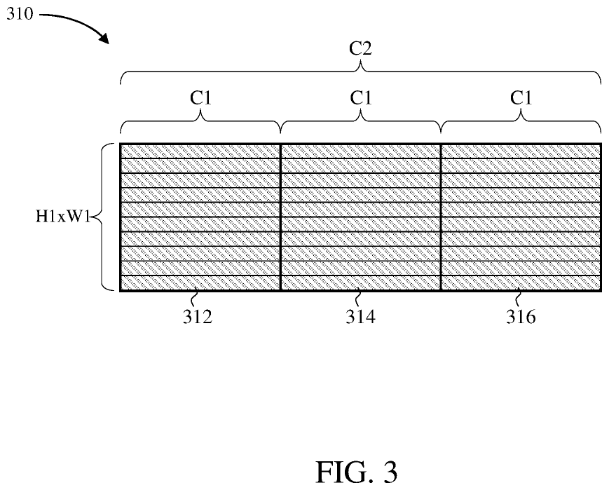

FIG. 3 shows a schematic diagram of an input tensor or input tile according to another embodiment of the present invention. As shown in FIG. 3, the input data 310 may be a 3D data, with the height (H) dimension being H1, the width (W) dimension being W1, and the channel (C) dimension being C2 (=3×C1). However, because the number of channels (C2) is greater than the width of the cache 134, the input data 310 is arranged in the cache 134 as shown in FIG. 2, namely the sub-tensor 312 (data of the first C1 channels), the sub-tensor 314 (data of the middle C1 channels), and the sub-tensor 316 (data of the last C1 channels) are arranged in the positions of the sub-tensor 212, sub-tensor 214, and sub-tensor 216, respectively. In other words, in the cache 134, the sub-tensor 314 immediately follows the sub-tensor 312, and the sub-tensor 316 immediately follows the sub-tensor 314. In this case, the computing circuit 136 can learn from the values of the parameters (including the height (H) parameter, the width (W) parameter, and the channel (C) parameter) of the instruction that the size of the input data 310 is H1×W1×3C1, and then learns, according to the width of the cache 134 and the data format of the tensors, that the input data 310 includes three sub-tensors (the number of channels of each sub-tensor is C1). In this way, the computing circuit 136 can read the sub-tensor 312, the sub-tensor 314, and the sub-tensor 316 at one time based on one instruction (which saves time compared to three reading operations each reading one sub-tensor at a time) and process the sub-tensor 312, sub-tensor 314, and sub-tensor 316 in parallel (i.e., processing the data of H1×W1×3C1 in total).

Note that in the example of FIG. 3, the target number of channels (i.e., 3C1) is greater than the sum (i.e., 2C1) of the number of channels of the sub-tensor 312 and the number of channels of the sub-tensor 314. In other embodiments, if the input data 310 includes only the sub-tensor 312 and sub-tensor 314 but not the sub-tensor 316, the target number of channels is equal to a sum of the number of channels of the sub-tensor 312 and the number of channels of the sub-tensor 314 (the target number of channels and the sum both being 2C1).

According to the above-discussed characteristics of the computing circuit 136, the computing circuit 136 can treat the input data 210 as a four-dimensional (4D) data according to the number of parameters of the instruction (e.g., when the instruction indicates that the dimensions [D, H, W, C] of the input data 210 are [3, H1, W1, C1], or treat the input data 210 as a 3D data (e.g., when the instruction indicates that the dimensions [H, W, C] of the input data 210 are [H1, W1, 3C1]).

In some embodiments of the present invention, when the cache 134 cannot store all the input tensor TSR_in, the output tensor TSR_out is divided into multiple output tiles in advance according to the size of the cache 134, and then, according to the position and size of each output tile, the position and size of an input tile corresponding to the output tile are determined. The following Equations (5) to (8) express the correspondence between the output tile and the input tile in the depth direction.

DoHighest=DoLowest+min(tileDo,Do−DoLowest)−1 (5)

DiLowest=clip(DoLowest×Sd−padding_depth,0,Di−1) (6)

DiHighest=min(DoHighest×Sd−padding_depth+Kd−1,Di−1) (7)

tileDi=DiHighest−DiLowest+1 (8)

where DoLowest is the start position of the output tile, tileDo is the length of the output tile, DoHighest is the final position of the output tile, DiLowest is the start position of the input tile, tileDi is the length of the input tile, and DiHighest is the final position of the input tile. People having ordinary skill in the art can deduce the equations for the height direction and the width direction based on Equations (5) to (8), so the details are omitted for brevity. Note that because a pooling operation does not change the dimension value in the channel direction, the input tensor has the same start position and size in the channel dimension as the output tensor.

During the operations, the DMA unit 132 reads the input tiles from the memory 120 into the cache 134 in order, and the computing circuit 136 processes the input tiles in order. However, in an alternative embodiment, if the cache 134 can store the entire input tensor TSR_in, the DMA unit 132 reads the entire input tensor TSR_in from the memory 120 into the cache 134, and the computing circuit 136 processes the entire input tensor TSR_in at one time. The input data 210 in FIG. 2 may represent an entire input tensor TSR_in (i.e., the input tensor TSR_in is deemed to include only one input tile) or one of the input tiles that the input tensor TSR_in contains.

Note that various approaches can be taken to divide the output tensor TSR_out, and the present invention is not limited to any division approach. In some embodiments, the division approach may be determined according to the required memory bandwidth when a 3D pooling operation is performed on the entire input tensor TSR_in.

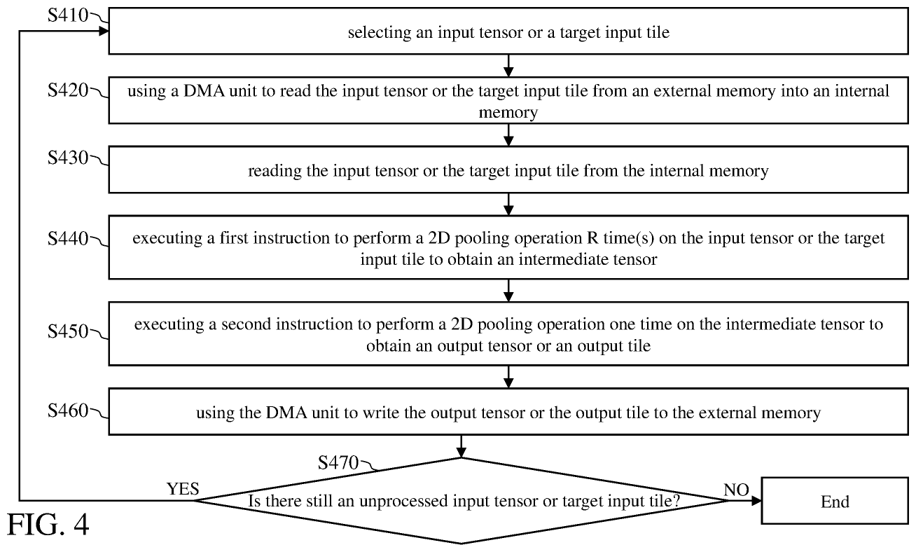

Reference is made to FIG. 4, which shows a flowchart of a 3D pooling operation according to an embodiment of the present invention. The process in FIG. 4 is executed by the IPU 130. The steps in FIG. 4 are discussed below in connection with FIG. 2.

Step S410: The IPU 130 selects an input tensor or a target input tile. For example, the input tensor or the target input tile can be the input data 210 in FIG. 2, and the input data 210 is stored in the memory 120 in FIG. 1.

Step S420: The IPU 130 uses the DMA unit 132 to read the input tensor or the target input tile from an external memory (i.e., the memory 120) into an internal memory (i.e., the cache 134).

Step S430: The vector core 138 of the computing circuit 136 reads the input tensor or the target input tile from the cache 134.

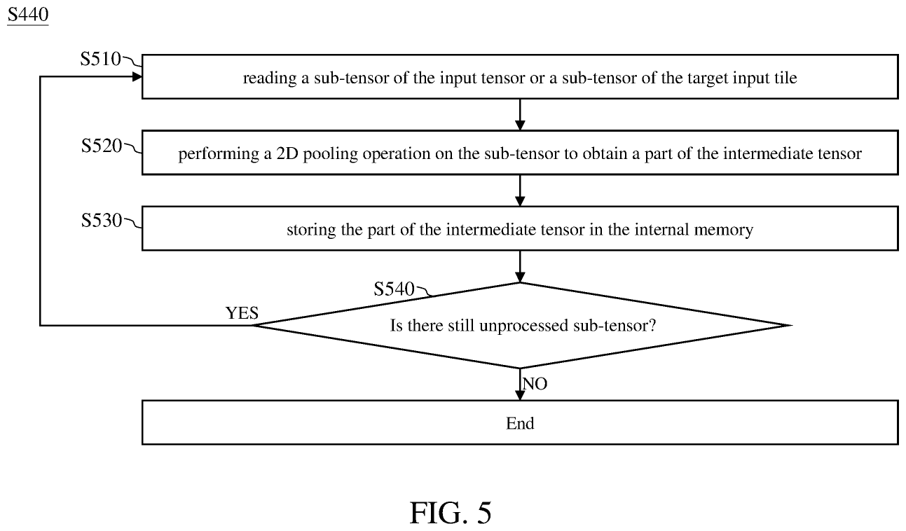

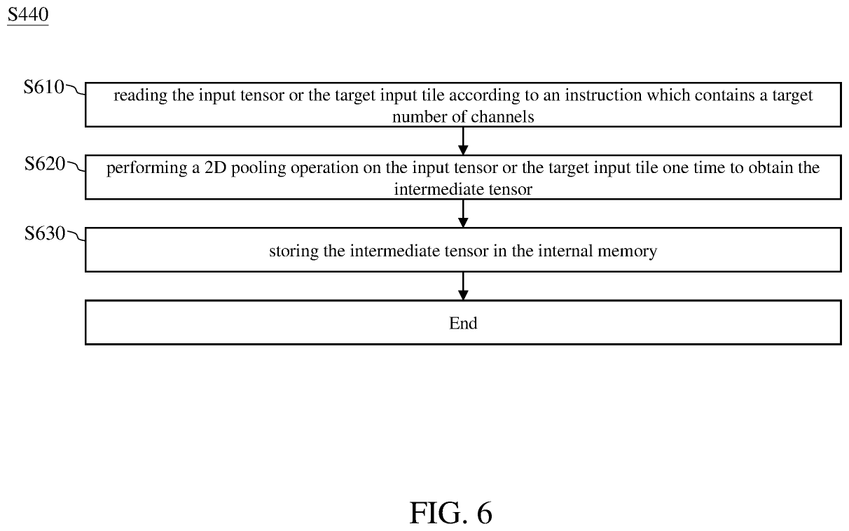

Step S440: The vector core 138 of the computing circuit 136 executes a first instruction to perform a 2D pooling operation R time(s) on the input tensor or the target input tile (R being a positive integer) to obtain an intermediate tensor (e.g., the intermediate data 220 in FIG. 2). If the first instruction indicates that the dimensions of the input tensor or the target input tile include the depth (D) dimension, the height (H) dimension, and the width (W) dimension, then R=Kd (please refer to Equation (3) or (4)). If the first instruction indicates that the dimensions of the input tensor or the target input tile include only two of the depth (D) dimension, the height (H) dimension, and the width (W) dimension (e.g., include only the height (H) and width (W) dimensions but not the depth (D) dimension), then R=1. The details of step S440 will be discussed below in connection with FIG. 5 or FIG. 6.

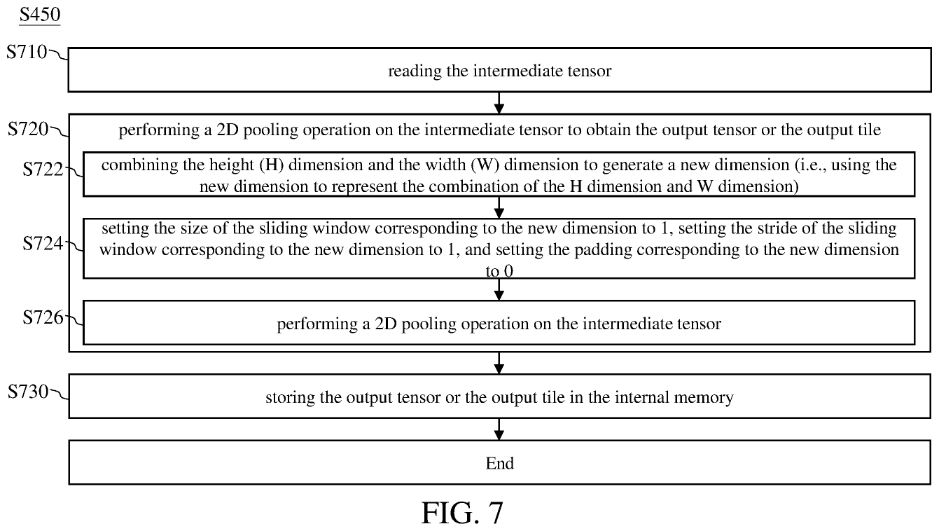

Step S450: The vector core 138 of the computing circuit 136 executes a second instruction to perform a 2D pooling operation one time on the intermediate tensor to obtain an output tensor or an output tile (e.g., the output data 230 of FIG. 2). The details of step S450 will be discussed below in connection with FIG. 7.

Step S460: The IPU 130 uses the DMA unit 132 to write the output tensor or the output tile to the external memory.

Step S470: The vector core 138 of the computing circuit 136 determines whether there is still an unprocessed input tensor or target input tile. If YES, then the process returns to step S410; if NO, the 3D pooling operation ends.

As shown in FIG. 4, the present invention does not directly perform a 3D pooling operation on the data, which requires hardware with high complexity and cost. On the contrary, the present invention uses a circuit with low complexity and cost (i.e., the vector core 138) to execute the instructions for two 2D pooling operations (i.e., step S440 and step S450, both of which are executed by the vector core 138), which is an equivalent of performing a 3D pooling operation. Therefore, the computing circuit 136 of the present invention has the advantages of low cost, low complexity, and easy implementation, making the IPU 130 more competitive.

FIG. 5 shows a detailed flowchart of step S440 in FIG. 4 (which includes steps S510 to S540) according to an embodiment. Steps S510 to S540 are discussed below in connection with FIG. 2.

Step S510: The vector core 138 of the computing circuit 136 reads a sub-tensor of the input tensor or a sub-tensor of the target input tile. Taking FIG. 2 as an example, the input data 210 includes the sub-tensor 212, sub-tensor 214, and sub-tensor 216. In this step, the computing circuit 136 reads one of the sub-tensor 212, sub-tensor 214, and sub-tensor 216. In some embodiments, the computing circuit 136 processes the sub-tensor 212, sub-tensor 214, and sub-tensor 216 in order.

Step S520: The vector core 138 of the computing circuit 136 performs a 2D pooling operation on the sub-tensor to obtain a part of the intermediate tensor TSR_imt (i.e., a sub-tensor of the intermediate tensor TSR_imt). Taking FIG. 2 as an example, the intermediate data 220 (i.e., the intermediate tensor TSR_imt) includes a sub-tensor 222, a sub-tensor 224, and a sub-tensor 226, corresponding respectively to the sub-tensors 212, 214 and 216. That is, the sub-tensors 222, 224, and 226 are the outcomes of a 2D pooling operation performed on sub-tensors 212, 214, and 216, respectively. In the example of FIG. 2, the 2D pooling operation changes the sub-tensor of H1×W1 into the sub-tensor of H2×W2. For example, if the dimensions [D, H, W, C] of the sub-tensor 212 (214 or 216) are [3, 5, 2, 16], the sizes [Kd, Kh, Kw] of the sliding window are [3, 3, 2], and the strides [Sd, Sh, Sw] of the sliding window are [1, 1, 1], then the dimensions [D, H, W, C] of the sub-tensor 222 (224 or 226) are [3, 3, 1, 16] (i.e., H2×W2=3×1=3).

Step S530: The vector core 138 of the computing circuit 136 stores the part of the intermediate tensor in the internal memory. In the example of FIG. 2, the computing circuit 136 stores the sub-tensor 222 (224 or 226) in the cache 134 in this step.

Step S540: The vector core 138 of the computing circuit 136 determines whether there is still an unprocessed sub-tensor. If YES, the computing circuit 136 performs step S510 to read the next sub-tensor; if NO, step S440 ends.

FIG. 6 shows a detailed flowchart of step S440 in FIG. 4 according to another embodiment. The flowchart of FIG. 6 includes steps S610 to S630. In the process of FIG. 6, the computing circuit 136 treats, according to the instructions, the input data 210 as a 3D tensor ([H, W, D×C]) instead of a 4D tensor ([D, H, W, C]). Steps S610 to S630 are discussed below in connection with FIG. 2.

Step S610: The vector core 138 of the computing circuit 136 reads the input tensor or the target input tile from the cache 134 according to an instruction which contains a target number of channels. In this step, the instruction that the computing circuit 136 executes indicates that the data to be processed (taking the input data 210 in FIG. 2 as an example) includes three dimension parameters: height H=H1, width W=W1, and channel C=3C1, but no depth (D) parameter. Note that “3C1” is the target number of channels in this example. In this case, the manner in which the computing circuit 136 reads the input data 210 has been discussed above in connection with FIG. 3, and the details are omitted for brevity.

Step S620: The vector core 138 of the computing circuit 136 performs a 2D pooling operation on the input tensor or the target input tile one time to obtain the intermediate tensor TSR_imt. Note that to obtain the complete intermediate data 220, the process in FIG. 5 has to perform a 2D pooling operation on the input data 210 three times (one each for the sub-tensor 212, sub-tensor 214, and sub-tensor 216) (i.e., R=Kd=3), whereas the process of FIG. 6 performs a 2D pooling operation on the input data 210 only one time (i.e., R=1). That is to say, to obtain the complete intermediate data 220, the vector core 138 of the computing circuit 136 needs to perform a 2D pooling operation on the input data 210 only one time in step S620, which is equivalent to processing all sub-tensors of the input data 210 in parallel.

Step S630: The vector core 138 of the computing circuit 136 stores the intermediate tensor in the internal memory.

FIG. 7 shows a detailed flowchart of step S450 in FIG. 4. The flowchart includes steps S710 to S730, which are discussed below in connection with FIG. 2.

Step S710: The vector core 138 of the computing circuit 136 reads the intermediate tensor TSR_imt from the cache 134.

Step S720: The vector core 138 of the computing circuit 136 performs a 2D pooling operation on the intermediate tensor to obtain the output tensor or the output tile. Note that this step is to implement a 1D pooling operation in the depth direction by performing a 2D pooling operation, and the details include the following steps S722 to S726.

Step S722: The vector core 138 of the computing circuit 136 combines the height (H) dimension and the width (W) dimension to generate a new dimension. Taking FIG. 2 as an example, the dimensions [D, H, W, C] of the intermediate tensor TSR_imt are [3, H2, W2, C1] (where “3” represents the three sub-tensors 222, 224 and 226). After step S722, the new dimensions [D, L, C] of the intermediate tensor TSR_imt are [3, L2, C1] (where L2=H2×W2). In other words, step S722 is to decrease the dimension of the intermediate tensor TSR_imt. In practice, step S722 can be realized by adjusting the parameters of the instruction; more specifically, by reducing a parameter (i.e., replacing the parameter of the height (H) dimension and the parameter of the width (W) dimension with the parameter of the L dimension), the vector core 138 treats the intermediate tensor TSR_imt as data with one less dimension.

Step S724: The vector core 138 of the computing circuit 136 sets the size of the sliding window corresponding to the new dimension to 1, sets the stride of the sliding window corresponding to the new dimension to 1, and sets the padding corresponding to the new dimension to 0 (i.e., no padding), so that the vector core 138 does not process the new dimension (i.e., the L dimension).

Step S726: The vector core 138 of the computing circuit 136 performs a 2D pooling operation on the intermediate tensor TSR_imt to obtain the output tensor or the output tile. Since the vector core 138 does not process the new dimension (i.e., the L dimension), the vector core 138 performing a 2D pooling operation on the intermediate tensor TSR_imt in this step is actually equivalent to the vector core 138 performing a 1D pooling operation on the intermediate tensor TSR_imt.

Step S730: The vector core 138 of the computing circuit 136 stores the output tensor or the output tile in the internal memory. Taking FIG. 2 as an example, the vector core 138 stores the output data 230 in the cache 134 in this step.

Note that in the subsequent processing, the shape (or dimensions) of the output data 230 can be reshaped from [D, L, C]=[1, 3, C1] to [D, H, W, C]=[1, 3, 1, C1]; that is, one dimension is added to the output data 230.

Although Equation (3) or Equation (4) shows that a 3D pooling operation is equivalent to a 2D pooling operation plus a 1D pooling operation (which, in theory, are respectively performed by a 2D vector core and a 1D vector core), the present invention uses the same vector core 138 to perform two 2D pooling operations (i.e., step S440 and step S450, step S450 being an equivalent of a 1D pooling operation, which is discussed in step S720). Therefore, the IPU 130 of the present invention is advantageous in terms of low cost and low complexity (i.e., no need to implement the 1D vector core).

In other embodiments, if the computing circuit 136 includes a 1D vector core that performs 1D pooling operations, then in step S450, the computing circuit 136 may alternatively use the 1D vector core to perform a 1D pooling operation on the intermediate data 220.

To sum up, the present invention cleverly uses one 2D pooling operation to equivalently implement a 1D pooling operation, which makes the use of two 2D pooling operations to equivalently implement a 3D pooling operation possible. Since a 2D pooling operation core (i.e., a 2D vector core) is lower in circuit cost and complexity compared to a 3D pooling operation core (i.e., a 3D vector core), and the present invention does not require an additional 1D pooling operation core (i.e., a 1D vector core), an electronic device employing the IPU of the present invention can improve efficiency without significantly increasing complexity and/or cost.

People having ordinary skill in the art can design the computing circuit 136 based on the above discussions. That is, the computing circuit 136 can be an Application Specific Integrated Circuit (ASIC), such as the aforementioned neural network computing core.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A three-dimensional (3D) pooling operation method for computing an input tensor to generate an output tensor, the input tensor comprising a plurality of input tiles, and the output tensor comprising a plurality of output tiles, the method comprising:
(A) reading from an external memory one of the input tiles as a target input tile and storing the target input tile in a memory;
(B) reading from the memory the target input tile;
(C) performing a first two-dimensional (2D) pooling operation on the target input tile R times to generate an intermediate tensor, R being a positive integer;
(D) performing a second 2D pooling operation on the intermediate tensor one time to generate a target output tile of the output tiles; and
(E) storing the target output tile in the memory.

2. The method of claim 1, wherein the intermediate tensor has a first dimension parameter and a second dimension parameter, the step (D) comprising:
using a third dimension parameter to represent a combination of the first dimension parameter and the second dimension parameter; and
setting a size of a sliding window corresponding to the third dimension parameter to one, setting a stride of the sliding window corresponding to the third dimension parameter to one, and setting a padding corresponding to the third dimension parameter to zero.

3. The method of claim 2, wherein a product of the first dimension parameter and the second dimension parameter is equal to the third dimension parameter.

4. The method of claim 1, wherein the memory stores a first sub-tensor and a second sub-tensor of the target input tile, the second sub-tensor immediately follows the first sub-tensor, the step (C) processes the first sub-tensor and the second sub-tensor, and R is one.

5. The method of claim 4, wherein the first sub-tensor has a first channel dimension, the second sub-tensor has a second channel dimension, the step (B) reads the first sub-tensor and the second sub-tensor in response to an instruction, and a target number of channels of the instruction is greater than or equal to a sum of the first channel dimension and the second channel dimension.

6. The method of claim 5, wherein the first channel dimension is equal to the second channel dimension.

7. The method of claim 5, wherein both the first channel dimension and the second channel dimension are equal to a width of the memory divided by a data format of the input tensor.

8. The method of claim 1, wherein the 3D pooling operation method corresponds to a sliding window, the step (C) performs the first 2D pooling operation on a first dimension and a second dimension, a size of the sliding window corresponding to a third dimension is R, and the third dimension is different from the first dimension and the second dimension.

9. The method of claim 8, wherein the third dimension is a depth dimension.

10. The method of claim 1, wherein the step (C) is performed by a 2D vector core, and the step (D) is performed by the 2D vector core.

11. An intelligence processing unit (IPU) for processing an input tensor and generating an output tensor, the input tensor comprising a plurality of input tiles, and the output tensor comprising a plurality of output tiles, the IPU comprising:
a memory;
a direct memory access (DMA) unit for reading from an external memory one of the input tiles as a target input tile and storing the target input tile in the memory; and
a computing circuit for performing following operations to perform a three-dimensional (3D) pooling operation on the target input tile, the 3D pooling operation generating a target output tile of the output tiles:
(A) reading from the memory the target input tile;
(B) performing a first two-dimensional (2D) pooling operation on the target input tile R times to generate an intermediate tensor, R being a positive integer; and
(C) performing a second 2D pooling operation on the intermediate tensor one time to generate the target output tile.

12. The IPU of claim 11, wherein the intermediate tensor has a first dimension parameter and a second dimension parameter, the step (C) comprising:
using a third dimension parameter to represent a combination of the first dimension parameter and the second dimension parameter; and
setting a size of a sliding window corresponding to the third dimension parameter to one, setting a stride of the sliding window corresponding to the third dimension parameter to one, and setting a padding corresponding to the third dimension parameter to zero.

13. The IPU of claim 12, wherein a product of the first dimension parameter and the second dimension parameter is equal to the third dimension parameter.

14. The IPU of claim 11, wherein the memory stores a first sub-tensor and a second sub-tensor of the target input tile, the second sub-tensor immediately follows the first sub-tensor, the computing circuit processes the first sub-tensor and the second sub-tensor in the step (B), and R is one.

15. The IPU of claim 14, wherein the first sub-tensor has a first channel dimension, the second sub-tensor has a second channel dimension, the computing circuit reads the first sub-tensor and the second sub-tensor in response to an instruction in the step (B), and a target number of channels of the instruction is greater than or equal to a sum of the first channel dimension and the second channel dimension.

16. The IPU of claim 15, wherein the first channel dimension is equal to the second channel dimension.

17. The IPU of claim 15, wherein both the first channel dimension and the second channel dimension are equal to a width of the memory divided by a data format of the input tensor.

18. The IPU of claim 11, wherein the 3D pooling operation corresponds to a sliding window, and the step (B) performs the first 2D pooling operation on a first dimension and a second dimension, a size of the sliding window corresponding to a third dimension is R, and the third dimension is different from the first dimension and the second dimension.

19. The IPU of claim 18, wherein the third dimension is a depth dimension.

20. The IPU of claim 11, wherein the computing circuit comprises a 2D vector core, and the step (B) and the step (D) are executed by the 2D vector core.
